(19) United States
(12) Patent Application Publication
(10) Pub. No.: US 2022/0097745 A1
(43) Pub. Date: Mar. 31, 2022

(54) GROUND CONTROL DEVICE AND PROTECTION ZONE CONTROL METHOD

(71) Applicant: Mitsubishi Electric Corporation, Chiyoda-ku, Tokyo (JP)

(72) Inventors: Katsunori TSUCHIDA, Tokyo (JP); Atsushi TAKAMI, Tokyo (JP); Tomohiro ONISHI, Tokyo (JP)

(73) Assignee: Mitsubishi Electric Corporation, Chiyoda-ku, Tokyo (JP)

(21) Appl. No.: 17/427,225

(22) PCT Filed: Feb. 5, 2019
(86) PCT No.: PCT/JP2019/004047

§ 371 Date: Jul. 30, 2021

(51) Int. Cl. B61L 27/00; B61L 25/04; B61L 25/02; B60L 15/40

(52) U.S. Cl. CPC B61L 27/00; B60L 15/40; B61L 25/023; B61L 25/04

(57) ABSTRACT

A ground control device includes: a location information acquiring unit to acquire location information indicating a train location from a train through a ground wireless device; an on-track information acquiring unit to acquire on-track information indicating whether or not the train is present on a track in a predetermined zone; and a control unit to set a protection zone for the train when the location information acquiring unit cannot acquire the location information, and to cancel a portion of the protection zone on the basis of the on-track information acquired by the on-track information acquiring unit when the train has run in an emergency driving mode.

### FIELD

The present invention relates to a ground control device that manages traffic of trains, and a protection zone control method.

### BACKGROUND

Conventionally, in a wireless train control system, a ground control device acquires location information on a train through wireless communication from the train, sets a stop limit position for the train on the basis of the acquired location information, and transmits information on the stop limit position to the train. The train runs so as not to pass over the stop limit position. When the ground control device cannot acquire location information from a certain train, the ground control device sets a zone from the location indicated by the location information last received from that train to the stop limit position as a protection zone, and prohibits another train from entering the protection zone. In the wireless train control system, as the ground control device sets a longer protection zone, the longer protection zone more significantly affects traffic of the subsequent trains, traffic of trains that are present on tracks in a station or stations located ahead of the train, and the like. Consequently, a traffic efficiency of trains is decreased.

To deal with this problem, Patent Literature 1 discloses a technique for a ground device in which, when an anomaly has occurred in wireless communication with a train, the ground device sets a range of a protection zone to be smaller so as to minimize a decrease in traffic efficiency of the trains. Specifically, the ground device disclosed in Patent Literature 1 sets a range between a train location last received from a train and a stoppable position at which the train can make an emergency stop, as a protection zone.

### CITATION LIST

### Patent Literature

Patent Literature 1: Japanese Patent Application

Laid-open No. 2013-10477

### SUMMARY

### Technical Problem

There is a method available to cope with a disruption in wireless communication between a ground device and a train. In this method, a driver of the train performs emergency driving in which the driver performs an emergency stop of the train, and thereafter communicates with a manager of the ground device or other personnel through a communication means other than a regular wireless communication means to drive the train to travel to the next station. However, in the technique disclosed in Patent Literature 1, there has been a problem that if a train runs in an emergency driving mode and passes over a protection zone set at the time of occurrence of an anomaly in wireless communication, that is, the stoppable position, any other trains cannot be prohibited from entering a train traveling zone due to the emergency driving mode.

The present invention has been made in view of the above circumstances, and an object of the present invention is to provide a ground control device that makes it possible to minimize a decrease in traffic efficiency of trains while prohibiting other trains from entering a train traveling zone in an emergency driving mode.

### Solution to Problem

In order to solve the above-mentioned problems and achieve the object, the present invention provide a ground control device comprising: a first information acquiring unit to acquire location information indicating a train location from a train through a ground wireless device; a second information acquiring unit to acquire on-track information indicating whether or not the train is present on a track in a predetermined zone; and a control unit to set a protection zone for the train when the first information acquiring unit cannot acquire the location information, and to cancel a portion of the protection zone on the basis of the on-track information acquired by the second information acquiring unit when the train has run in an emergency driving mode.

### Advantageous Effects of Invention

According to the present invention, the ground control device has an advantageous effect that it is possible to minimize a decrease in traffic efficiency of trains while prohibiting the trains from entering a train traveling zone in an emergency driving mode.

### BRIEF DESCRIPTION OF DRAWINGS

FIG. 1 is a diagram illustrating a configuration example of a wireless train control system according to a first embodiment.

FIG. 2 is a flowchart illustrating an operation of a control unit in a ground control device according to the first embodiment to control a protection zone for a train.

FIG. 3 is a diagram illustrating a track circuit in an opened state in the wireless train control system according to the first embodiment.

FIG. 4 is a diagram illustrating the track circuit in a closed state in the wireless train control system according to the first embodiment.

FIG. 5 is a diagram illustrating a state where the control unit has cancelled a portion of the protection zone in the wireless train control system according to the first embodiment.

FIG. 6 is a diagram illustrating an example in which a processing circuit included in the ground control device according to the first embodiment is configured using a processor and a memory.

FIG. 7 is a diagram illustrating an example of the processing circuit included in the ground control device according to the first embodiment when the processing circuit is configured by dedicated hardware.

FIG. 8 is a flowchart illustrating an operation of a control unit in a ground control device according to a second embodiment to control a protection zone for a train.

FIG. 9 is a diagram illustrating a state in which the train is present on a track in a track circuit in a wireless train control system according to the second embodiment.

FIG. 10 is a diagram illustrating a state of the wireless train control system according to the second embodiment, in which the train is present on a track in the track circuit for a prescribed period and a portion of the protection zone is canceled.

### DESCRIPTION OF EMBODIMENTS

A ground control device and a protection zone control method according to embodiments of the present invention will be described in detail below with reference to the drawings. The present invention is not necessarily limited by these embodiments.

### First Embodiment

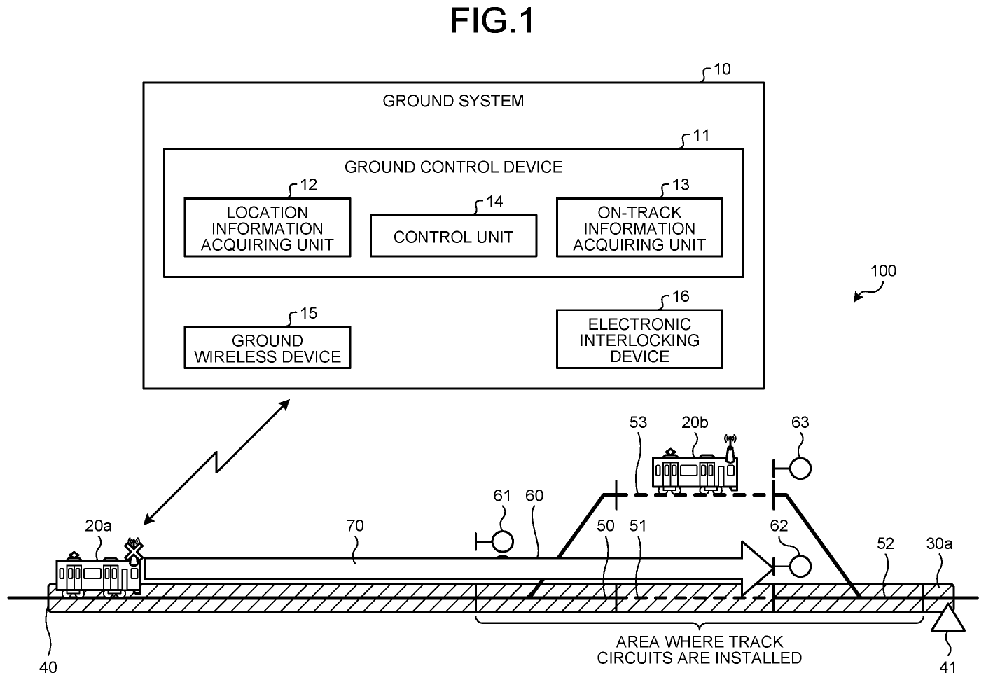

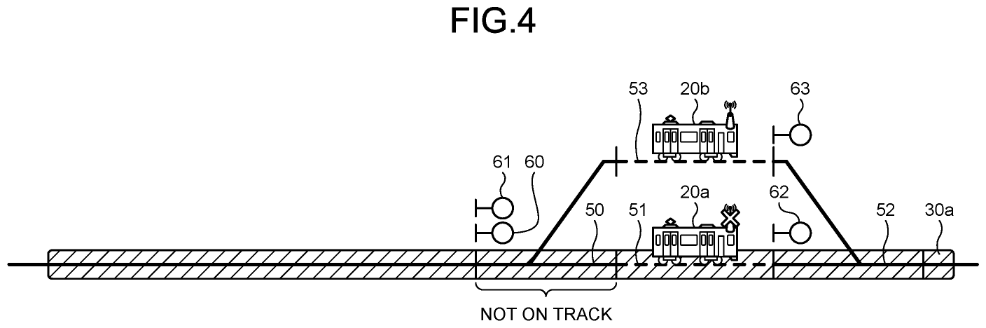

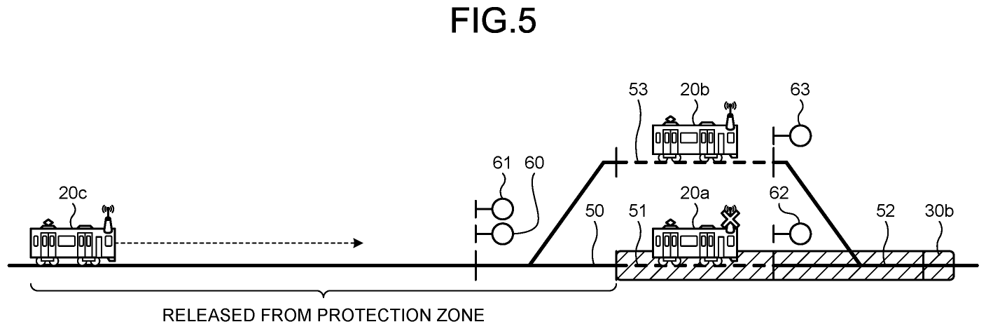

FIG. 1 is a diagram illustrating a configuration example of a wireless train control system 100 according to a first embodiment of the present invention. The wireless train control system 100 includes a ground system 10 and trains 20a and 20b. In the following descriptions, the trains 20a and 20b, and a train 20c illustrated in FIG. 5 which is described later are sometimes referred collectively to as “train(s) 20” when these trains are not distinguished from each other. The train 20c is also included in the wireless train control system 100. The area illustrated in FIG. 1 corresponds to a part of an area where the ground system 10 controls traffic of the trains 20 in the wireless train control system 100. The area illustrated in FIG. 1 is defined as an area in which the trains 20 having the same traveling direction can stop in parallel to each other, which is for example, an area in railway station vicinities where a platform (not illustrated) and the like are set up. In the railway station vicinity, that is, in the “area where track circuits are installed” illustrated in FIG. 1, track circuits 50 to 53 configured to detect whether or not the train 20 is present on a track, and signals 61 to 63 configured to indicate “stop” and “go” of the train 20 are installed. It is noted that a signal 60 is installed in the railway station vicinity although the signal 60 is hidden by an arrow given to a travelling zone 70 for the train 20a running in an emergency driving mode in FIG. 1. The signal 60 is illustrated in FIG. 4 and other diagrams and described later.

Now the configuration of the ground system 10 will be described. The ground system 10 includes a ground control device 11, a ground wireless device 15, and an electronic interlocking device 16.

The ground control device 11 manages traffic of the trains 20. The ground control device 11 includes a location information acquiring unit 12, an on-track information acquiring unit 13, and a control unit 14.

The location information acquiring unit 12 is a first information acquiring unit configured to acquire location information from the train 20 through the ground wireless device 15, the location information indicating a train location of the train 20, and to output the obtained location information to the control unit 14. The location information acquiring unit 12 outputs control information such as a stop limit position generated in the control unit 14 to the train 20 through the ground wireless device 15.

The on-track information acquiring unit 13 is a second information acquiring unit configured to acquire on-track information indicating whether or not the train 20 is present on a track in a predetermined zone. In the example of the wireless train control system 100 illustrated in FIG. 1, the on-track information acquiring unit 13 acquires, from the electronic interlocking device 16, on-track information indicating whether the track circuits 50 to 53 are in an opened state or a closed state. The track circuits 50 to 53 being in an opened state refers to the state in which the train 20 is present on a track. The track circuits 50 to 53 being in a closed state refers to a non-on-track state in which the train 20 is not present on a track. When the track circuits 50 to 53 are brought into a closed state after having been in an opened state, this indicates that the train 20 has passed through the corresponding track circuits.

When the control unit 14 acquires location information on the train 20 from the location information acquiring unit 12 through the ground wireless device 15, the control unit 14 sets a stop limit position for the train 20 on the basis of the location information on the train 20. The control unit 14 executes control to transmit information on the stop limit position from the ground wireless device 15 through the location information acquiring unit 12 to the train 20. When the location information acquiring unit 12 cannot acquire location information from the train 20a, the control unit 14 sets a protection zone 30a for the train 20a. After the control unit 14 has set the protection zone 30a for the train 20a, when the train 20a has run in an emergency driving mode, the control unit 14 cancels a portion of the protection zone 30a on the basis of on-track information acquired by the on-track information acquiring unit 13. In the wireless train control system 100, when a protection zone for a certain train 20 is cancelled, this makes it possible for another train 20 to enter the protection zone having been cancelled. A specific operation of the control unit 14 is described later.

The ground wireless device 15 wirelessly communicates with the trains 20. When the ground wireless device 15 acquires location information from the train 20, the ground wireless device 15 outputs the acquired location information to the location information acquiring unit 12 in the ground control device 11. When the ground wireless device 15 acquires information on a stop limit position for the train 20 from the ground control device 11, the ground wireless device 15 transmits the acquired information on a stop limit position to the train 20. In the wireless train control system 100 illustrated in FIG. 1, the ground system 10 has a single ground wireless device 15, but this singularity is merely an example, and so the ground system 10 may have two or more ground wireless devices 15.

The electronic interlocking device 16 controls operations of the signals 60 to 63. The electronic interlocking device 16 acquires, from the track circuits 50 to 53, on-track information indicating whether each of the track circuits 50 to 53 is in an opened state or a closed state, and outputs the acquired on-track information to the on-track information acquiring unit 13 in the ground control device 11.

In the train 20, an onboard control device (not illustrated) generates a run curve in response to acquiring the information on a stop limit position from the ground control device 11, and controls running of the train 20 in accordance with the run curve. The configuration of the train 20 may be made similar to the configuration of a train used in a general wireless train control system. Therefore, detailed descriptions of the configuration of the train 20 are omitted.

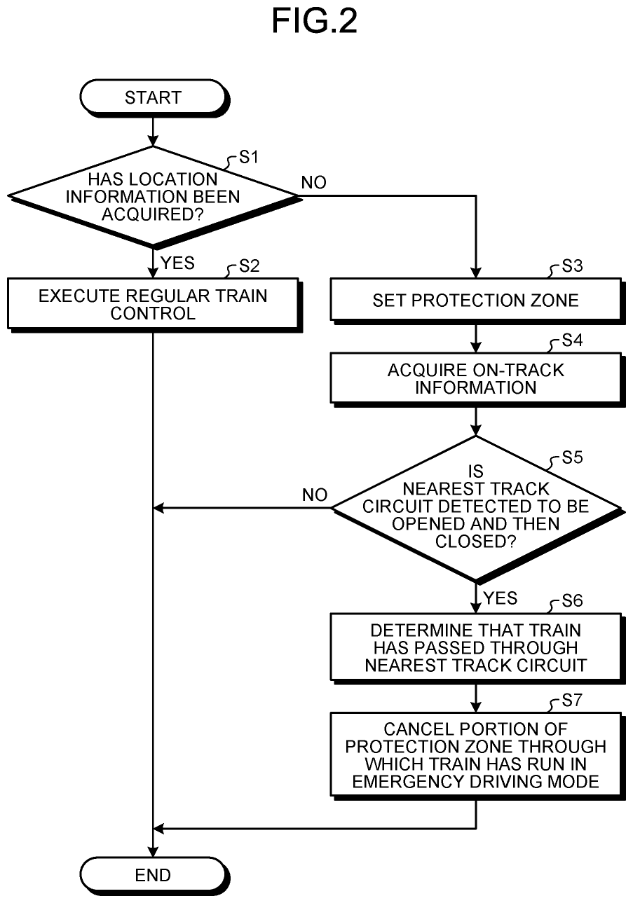

Next, an operation of the ground control device 11 is described. FIG. 2 is a flowchart illustrating an operation of the control unit 14 in the ground control device 11 according to the first embodiment to control a protection zone for the train 20a. In the ground control device 11, the control unit 14 determines whether or not the location information has been obtained from the train 20a through the ground wireless device 15 and the location information acquiring unit 12 (Step S1). When the location information has been acquired (YES at Step S1), the control unit 14 executes a regular train control (Step S2). The regular train control refers to control to set a stop limit position 41 on the basis of the location information acquired from the train 20a, and transmit information on the stop limit position 41 to the train 20a.

When the location information cannot be acquired (NO at Step S1), the control unit 14 sets a protection zone 30a (Step S3). The protection zone 30a has a starting point at a trailing position 40 of the train 20a indicated by the location information last acquired from the train 20a, and has an ending point at the stop limit position 41 set on the basis of the location information last acquired from the train 20a. Examples of the case where the control unit 14 cannot acquire any location information from the train 20a include, but are not limited to, a fault in an onboard wireless device (not illustrated) installed in the train 20a, a fault in an onboard control device (not illustrated) installed in the train 20a to calculate the location of the train 20a, and a fault in the ground wireless device 15. Examples of the case where the control unit 14 cannot acquire any location information from the train 20a also include a case of disconnection of communication between the ground wireless device 15 and the train 20a due to temporary deterioration of their communication environment. It is allowable that when location information cannot be acquired for a predetermined period, the control unit 14 determines that the location information has been unable to be acquired.

The train 20a stops when the train 20a cannot acquire the information on its stop limit position from the ground control device 11 with the predetermined period. A manager of the ground control device 11 instructs a driver of the train 20a to perform emergency driving for the train 20a, using a communication means such as a backup radio device or a mobile terminal. The communication means does not use the ground wireless device 15 or the onboard wireless device described above. The driver of the train 20a drives the train 20a in an emergency driving mode in accordance with the instruction from the manager of the ground control device 11.

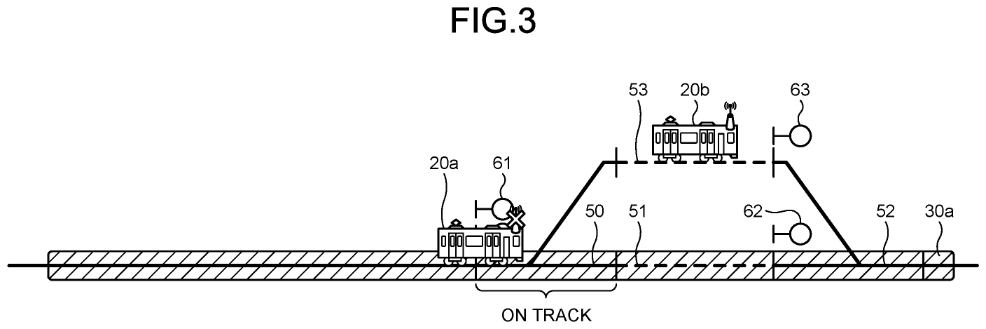

The control unit 14 acquires on-track information indicating the state of the track circuits 50 to 53 from the electronic interlock device 16 through the on-track information acquiring unit 13 (Step S4). The control unit 14 determines whether or not the nearest track circuit within the range of the protection zone 30a, which is the track circuit 50 in the example in FIG. 1, is detected to be opened and then closed (Step S5). FIG. 3 is a diagram illustrating a state in which the track circuit 50 is in an opened state in the wireless train control system 100 according to the first embodiment. FIG. 4 is a diagram illustrating a state in which the track circuit 50 is in a closed state in the wireless train control system 100 according to the first embodiment. When the train 20a running in an emergency driving mode enters the track circuit 50, the control unit 14 determines that the train 20a is present on a track in the track circuit 50 on the basis of the acquired on-track information about “opened”. Thereafter, when the train 20a running in an emergency driving mode leaves the track circuit 50, the control unit 14 determines that the train 20a is not present on a track in the track circuit 50, that is, determines non-on-track, on the basis of the acquired on-track information about “closed”. When the track circuit 50 is not detected to be opened or closed (NO at Step S5), the control unit 14 ends the processing.

When the track circuit 50 is detected to be opened and then closed (YES at Step S5), the control unit 14 determines that the train 20a has passed through the nearest track circuit, that is, the track circuit 50 in the example in FIG. 1 (Step S6). The control unit 14 releases a portion from the trailing position 40 of the train 20a that is the starting point of the protection zone 30a to the track circuit 50 through which the train 20a has passed, that is, a portion through which the train 20a has run in an emergency driving mode, from a protection zone (Step S7). FIG. 5 is a diagram illustrating a state where the control unit 14 has cancelled a portion of the protection zone 30a in the wireless train control system 100 according to the first embodiment. In this manner, when a zone portion through which the train 20 running in an emergency driving mode has passed is identified on the basis of the on-track information from the on-track information acquiring unit 13, the control unit 14 cancels a portion of the protection zone from the starting point to the portion through which the train 20 has passed. As a result, when the train 20 has run in an emergency driving mode, the control unit 14 can narrow the range of the protection zone in accordance with the zone portion through which the train 20 has run. Specifically, in the example in FIG. 1 and FIGS. 3 to 5, the control unit 14 can narrow the protection zone 30a for the train 20a down to a protection zone 30b. With this operation, the control unit 14 can control the train 20c following the train 20a so that the train 20c is allowed to enter the track circuit 50.

The control unit 14 periodically repeats the operation in the flowchart illustrated in FIG. 2. For example, when the control unit 14 determines that the train 20a has passed through the track circuit 51 in an emergency driving mode, the control unit 14 additionally releases a portion used for the track circuit 51 from the protection zone.

As describe above, in the first embodiment, the on-track information is information indicating that each of the track circuits 50 to 53 is opened and then closed. When a certain track circuit is detected to be opened and then closed on the basis of the on-track information, the control unit 14 determines that the train 20 has passed through the certain track circuit, and releases a portion from the starting point to the track circuit through which the train 20 has passed, from the protection zone.

The method of determining whether the train 20 is present on an appropriate track is not limited to this example. For example, it is allowable to install axle counters at opposite ends of each zone illustrated by the track circuits 50 to 53 in FIG. 1 and FIGS. 3 to 5, that is, at the starting point and the ending point of each zone. The control unit 14 acquires, from the on-track information acquiring unit 13, on-track information that is an information set indicating a count value of each of the axle counters in the installation zone where the axle counters are installed at opposite ends. In this case, the on-track information is an information set indicating a count value of each of the axle counters in the installation zone where the axle counters are installed at opposite ends thereof. On the basis of the on-track information, when the count values of the axle counters are equal, but each are not equal to zero, the control unit 14 determines that the train 20 has passed through the installation zone, and cancels a protection zone from the starting point to the installation zone. Also in this case, when the train 20 has run in an emergency driving mode, the control unit 14 can narrow the range of the protection zone down in accordance with the zone portion through which the train 20 has run.

Next, the hardware configuration of the ground control device 11 is described. In the ground control device 11, the location information acquiring unit 12 is an input-output interface through which it is possible to input and output information between the ground control device 11 and the ground wireless device 15. The on-track information acquiring unit 13 is an input interface to acquire on-track information from the electronic interlocking device 16. The control unit 14 is implemented by a processing circuit. The processing circuit may be either dedicated hardware, or a memory and a processor that executes a program stored in the memory.

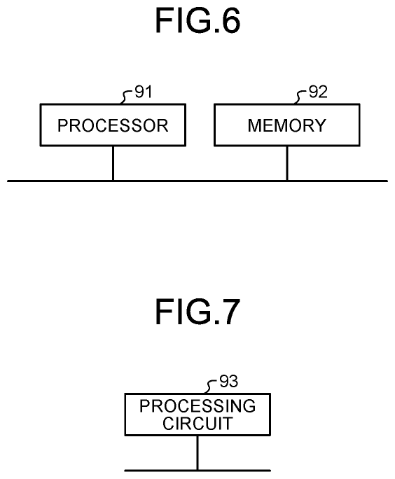

FIG. 6 is a diagram illustrating an example in which the processing circuit included in the ground control device 11 according to the first embodiment is configured using a processor and a memory. In a case where the processing circuit is configured using a processor 91 and a memory 92, the functions of the processing circuit for the ground control device 11 are implemented in software, firmware, or a combination of software and firmware. The software or firmware is described as a program and stored in the memory 92. In the processing circuit, the processor 91 reads and executes the program stored in the memory 92 to thereby implement each of the functions. That is, the processing circuit includes the memory 92 configured to store therein programs by which the processing of the ground control device 11 is eventually carried out. These programs are also regarded as causing a computer to execute the procedure and method of the ground control device 11.

The processor 91 may be a device such as a CPU (Central Processing Unit), a processing device, an arithmetic device, a microprocessor, a microcomputer, or a DSP (Digital Signal Processor). Further, the memory 92 corresponds to: for example, a nonvolatile or volatile semiconductor memory such as a RAM (Random Access Memory), a ROM (Read Only Memory), a flash memory, an EPROM (Erasable Programmable ROM), and an EEPROM (registered trademark) (Electrically EPROM); a magnetic disk; a flexible disk; an optical disk; a compact disk; a MiniDisk; a DVD (Digital Versatile Disk); or the like.

FIG. 7 is a diagram illustrating an example of the processing circuit included in the ground control device 11 according to the first embodiment when the processing circuit is configured by a dedicated hardware set. When the processing circuit is configured in dedicated hardware, a processing circuit 93 illustrated in FIG. 7 corresponds to, for example, a single circuit, a composite circuit, a programmed processor, a parallel-programmed processor, an ASIC (Application Specific Integrated Circuit), an FPGA (Field Programmable Gate Array), or any combination of them. Each of the functions of the ground control device 11 may be realized by the processing circuit 93 for each function, and these functions may be collectively realized by the processing circuit 93.

As for the functions of the ground control device 11, some of the functions may be realized in dedicated hardware and the remainder thereof may be realized in software or firmware. In this manner, the processing circuit can implement each function described above based on dedicated hardware, software, firmware, or any combination of them.

As described above, according to the present embodiment, in the ground control device 11, when the location information cannot be acquired from the train 20, the control unit 14 sets a protection zone on the basis of the location information last acquired from the train 20. When the train 20 has run in an emergency driving mode, the control unit 14 cancels a portion of the set protection zone on the basis of the on-track information on the track circuits 50 to 53. Specifically, the control unit 14 releases a portion through which the train 20a has run in an emergency driving mode, from the protection zone. With this operation, the ground control device 11 can minimize a decrease in traffic efficiency of the train 20 while prohibiting the train 20 from entering the traveling zone of the train 20 under the emergency driving conditions.

### Second Embodiment

In the first embodiment, the control unit 14 in the ground control device 11 cancels a rearward portion of the protection zone 30a set for the train 20a in the traveling direction of the train 20a. In a second embodiment, the control unit 14 cancels a forward portion of the protection zone 30b set for the train 20a in the traveling direction of the train 20a.

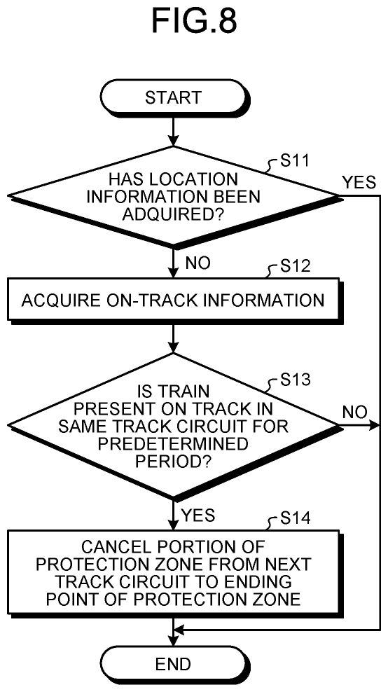

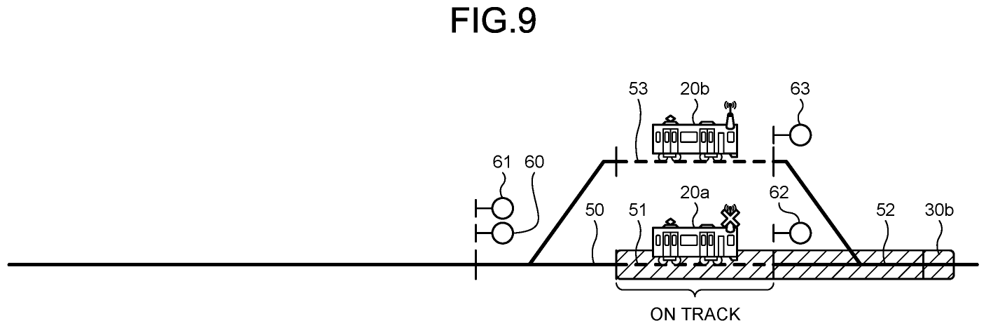

In the second embodiment, the configuration of the wireless train control system 100 and the ground system 10 is identical to that of the wireless train control system 100 and the ground system 10 according to the first embodiment illustrated in FIG. 1. FIG. 8 is a flowchart illustrating an operation of the control unit 14 in the ground control device 11 according to the second embodiment to control a protection zone for the train 20a. In the ground control device 11, the control unit 14 determines whether or not the location information has been obtained from the train 20a through the ground wireless device 15 and the location information acquiring unit 12 (Step S11). When the location information has been acquired (YES at Step S11), the control unit 14 ends the processing. When the location information cannot be acquired (NO at Step S11), the control unit 14 acquires the on-track information indicating the states of the track circuits 50 to 53 from the electronic interlocking device 16 through the on-track information acquiring unit 13 (Step S12). The control unit 14 determines whether or not the train 20a has been present on a track in the same track circuit for a predetermined period within the range of the protection zone 30b (Step S13). The wording “the train 20a has been present on a track in the same track circuit for a predetermined period” means a state in which, for example, for a sufficient time equal to or longer than the time required for the train 20a to run through a length of the opened track circuit at a very low speed, the state of track circuits respectively located forward and rearward relative to the opened track circuit remains unchanged, that is, remains closed. In such a case, the control unit 14 determines that the train 20a stops continuously on the opened track circuit. FIG. 9 is a diagram illustrating a state in which the train 20a is present on a track in the track circuit 51 in the wireless train control system 100 according to the second embodiment.

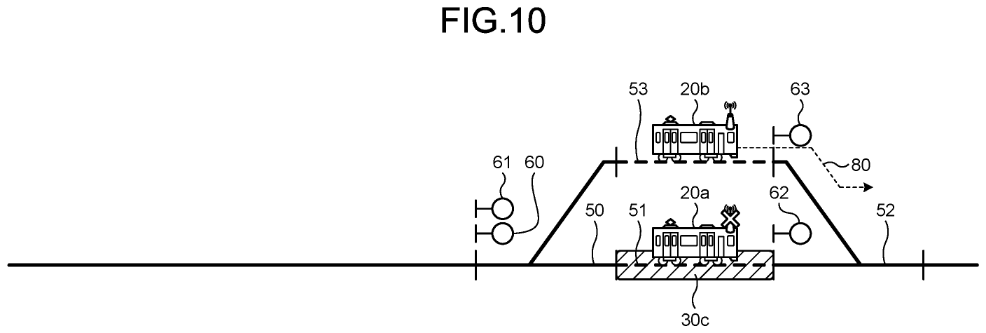

When the train 20a has not been present on a track in the same track circuit for a predetermined period within the range of the protection zone 30b (NO at Step S13), the control unit 14 ends the processing. When the train 20a has been present on a track in the same track circuit for a predetermined period within the range of the protection zone 30b (YES at Step S13), the control unit 14 releases a portion of the protection zone between the track circuit 52 next to the track circuit 51 in which the train 20a is present on a track and the ending point of the protection zone 30b, from the protection object (Step S14). FIG. 10 is a diagram illustrating a state of the wireless train control system 100 according to the second embodiment in which the train 20a has been present on a track in the track circuit 51 for a predetermined period, and a portion of the protection zone 30b is canceled. In this manner, on the basis of the on-track information from the on-track information acquiring unit 13, when the train 20a has been present on a track in the same track circuit for a predetermined period, the control unit 14 cancels a portion of the protection zone from the track circuit 52 next to the track circuit 51 on which the train 20a is present on a track to the ending point of the protection zone 30b. As a result, when the train 20 stops after having run in an emergency driving mode, and then the train 20 has been present on a track in the same track circuit for the predetermined period, the control unit 14 estimates the train 20 not to run until a faulty device thereof is repaired or replaced, and thus can cancel a forward portion of the protection zone to narrow the range of the protection zone down. Specifically, in the example in FIGS. 9 and 10, the control unit 14 can narrow the protection zone 30b for the train 20a down to a protection zone 30c. As a result, the control unit 14 allows the train 20b to operate.

The control unit 14 may perform the operation in the flowchart according to the first embodiment illustrated in FIG. 2 and the operation in the flowchart according to the second embodiment illustrated in FIG. 8 alternately or in parallel.

As described above, according to the present embodiment, in the ground control device 11, when the control unit 14 determines that the train 20a has stopped continuously for a predetermined period in the middle of the protection zone 30b having been set, on the basis of the on-track information on the track circuits 50 to 53, the control unit 14 releases a portion between a zone immediately ahead of the zone where the train 20a stops and the ending point of the protection zone 30b, from the protection object. With this operation, as compared to the first embodiment, the ground control device 11 can further minimize a decrease in traffic efficiency of the trains 20 while prohibiting the other train 20 from entering the traveling zone of the train 20 that is subjected to the emergency driving.

The configurations described in the above embodiments are examples of the content of the present invention, and can each be combined with other publicly known techniques and partially omitted and/or modified without departing from the scope of the present invention.

### REFERENCE SIGNS LIST

10 ground system; 11 ground control device; 12 location information acquiring unit; 13 on-track information acquiring unit; 14 control unit; 15 ground wireless device; 16 electronic interlocking device; 20a to 20c train; 30a to 30c protection zone; 40 trailing position; 41 stop limit position; 50 to 53 track circuit; 60 to 63 signal; 70 travelling zone in an emergency driving mode; 100 wireless train control system.

1. A ground control device comprising:
a first information acquiring unit to acquire location information indicating a train location from a train through a ground wireless device;
a second information acquiring unit to acquire on-track information indicating whether or not the train is present on a track in a predetermined zone; and
a control unit to set a protection zone for the train when the first information acquiring unit cannot acquire the location information, and to cancel a portion of the protection zone on the basis of the on-track information acquired by the second information acquiring unit when the train has run in an emergency driving mode,
wherein when the first information acquiring unit cannot acquire the location information, the control unit sets the protection zone having a starting point at a trailing position of the train indicated by location information last acquired from the train and an ending point at a stop limit position set on the basis of location information last acquired from the train, and when a zone through which the train running in an emergency driving mode has passed is identified on the basis of the on-track information, the control unit cancels a portion of the protection zone from the starting point to a zone through which the train has passed.

2. (canceled)

3. The ground control device according to claim 1, wherein
the on-track information is information indicating that a track circuit is opened and then closed, and
when a certain track circuit is detected to be opened and then closed on the basis of the on-track information, the control unit determines that the train has passed through the certain track circuit, and cancels a portion of the protection zone from the starting point to the track circuit through which the train has passed.

4. The ground control device according to claim 1, wherein
the on-track information is information indicating a count value of an axle counter in an installation zone where axle counters are installed at opposite ends thereof, and
on the basis of the on-track information, when count values of the axle counters are equal but other than zero, the control unit determines that the train has passed through the installation zone, and cancels a portion of the protection zone from the start point to the installation zone.

5. The ground control device according to claim 1, wherein when the control unit determines that the train has stopped for a predetermined period in the middle of the protection zone having been set, on the basis of the on-track information, the control unit cancels a portion of the protection zone from a zone immediately ahead of the zone where the train stops to the ending point.

6. A protection zone control method in a ground control device, the method comprising:
a first step of, by a first information acquiring unit, acquiring location information indicating a train location from a train through a ground wireless device;
a second step of, by a second information acquiring unit, acquiring on-track information indicating whether or not the train is present on a track in a predetermined zone; and
a third step of, by a control unit, setting a protection zone for the train when the first information acquiring unit cannot acquire the location information, and canceling a portion of the protection zone on the basis of the on-track information acquired by the second information acquiring unit when the train has run in an emergency driving mode,
wherein at the third step, when the first information acquiring unit cannot acquire the location information, the control unit sets the protection zone having a starting point at a trailing position of the train indicated by location information last acquired from the train and an ending point at a stop limit position set on the basis of location information last acquired from the train, and when a zone through which the train running in an emergency driving mode has passed is identified on the basis of the on-track information, the control unit cancels a portion of the protection zone from the starting point to a zone through which the train has passed.

7. (canceled)

8. The protection zone control method according to claim 6, wherein
the on-track information is information indicating that a track circuit is opened and then closed, and
at the third step, when a certain track circuit is detected to be opened and then closed on the basis of the on-track information, the control unit determines that the train has passed through the certain track circuit, and cancels a portion of the protection zone from the starting point to the track circuit through which the train has passed.

9. The protection zone control method according to claim 6, wherein
the on-track information is information indicating a count value of an axle counter in an installation zone where axle counters are installed at opposite ends thereof, and
at the third step, on the basis of the on-track information, when count values of the axle counters are equal but other than zero, the control unit determines that the train has passed through the installation zone, and cancels a portion of the protection zone from the starting point to the installation zone.

10. The protection zone control method according to claim 6, wherein at the third step, when the control unit determines that the train has stopped for a predetermined period in the middle of the protection zone having been set on the basis of the on-track information, the control unit cancels a portion of the protection zone from a zone immediately ahead of the zone where the train stops to the ending point.

11. The ground control device according to claim 3, wherein when the control unit determines that the train has stopped for a predetermined period in the middle of the protection zone having been set, on the basis of the on-track information, the control unit cancels a portion of the protection zone from a zone immediately ahead of the zone where the train stops to the ending point.

12. The ground control device according to claim 4, wherein when the control unit determines that the train has stopped for a predetermined period in the middle of the protection zone having been set, on the basis of the on-track information, the control unit cancels a portion of the protection zone from a zone immediately ahead of the zone where the train stops to the ending point.

13. The protection zone control method according to claim 8, wherein at the third step, when the control unit determines that the train has stopped for a predetermined period in the middle of the protection zone having been set on the basis of the on-track information, the control unit cancels a portion of the protection zone from a zone immediately ahead of the zone where the train stops to the ending point.

14. The protection zone control method according to claim 9, wherein at the third step, when the control unit determines that the train has stopped for a predetermined period in the middle of the protection zone having been set on the basis of the on-track information, the control unit cancels a portion of the protection zone from a zone immediately ahead of the zone where the train stops to the ending point.
